(19) United States
(12) Patent Application Publication
(10) Pub. No.: US 2022/0172225 A1
(43) Pub. Date: Jun. 2, 2022

(54) SYSTEMS AND METHODS FOR CANNABIS PRODUCT AUTHENTICATION AND VERIFICATION

(71) Applicant: THE BAR CODE REGISTRY, INC., Rancho Santa Fe, CA (US)

(72) Inventor: Erik Quisling, Rancho Santa Fe, CA (US)

(21) Appl. No.: 17/473,286

(22) Filed: Sep. 13, 2021

Related U.S. Application Data
(63) Continuation-in-part of application No. 17/109,113, filed on Dec. 1, 2020.

(51) Int. Cl. G06Q 30/00; G06F 16/23; G06Q 10/08; G06K 7/14; G06K 9/62

(52) U.S. Cl. CPC G06Q 30/0185; G06F 16/2379; G06K 9/6201; G06K 7/1413; G06Q 10/087

(57) ABSTRACT

A method comprising using at least one hardware processor to: receive a request to generate a first code to be associated with a cannabis producer; receive licensing information for the cannabis producer; verify the licensing information; receive product information related to the cannabis product; receive a list of approved vendors and their locations who can sell the cannabis product; generate the first code; update a master database with the first code, licensing information, product information, and list of approved vendors and locations; receive a scan of a second code associated with a cannabis product; and verify the legitimacy of the second code using the master database.

### CROSS-REFERENCE TO RELATED APPLICATIONS

This application claims priority as a continuation-in-part to U.S. patent application Ser. No. 17/109,113, entitled “Systems and Methods for Product Authentication and Verification,” filed on Dec. 1, 2020, which is incorporated herein by reference as if set forth in full. This application is also is related to U.S. Provisional Patent App. No. 62/437,480, filed on Dec. 21, 2016 and U.S. Provisional Patent App. No. 62/688,804, filed on Jun. 22, 2018, which are both hereby incorporated herein by reference as if set forth in full.

### BACKGROUND

### Field of the Invention

The embodiments described herein are generally directed to authenticating products and verifying the product source, and, more particularly, to an app. based system that allows consumers to authenticate a product using a code on the product and verifying the source of the product.

### Description of the Related Art

Counterfeiting of goods is a costly and growing problem. Currently, 7% or more of the global trade in goods are counterfeit. These counterfeits drain $4.2 Trillion from the global economy. Moreover, it is estimated that $200 billion is spent annually on fake pharmaceuticals, which can have tragic consequence. But beyond the direct monetary loses, not to mention the potential loss of life, counterfeiting can indirectly impact the goodwill that product developers have built in their brands.

Conventional approaches to brand protection and anti-counterfeiting often focus on including security features in the packaging, such as holograms, 2-D barcodes, RFID, other visible features, hidden features, etc. But the problem continues to grow.

### SUMMARY

Accordingly, systems, methods, and non-transitory computer-readable media are disclosed to anti-counterfeiting and product authentication and verification.

According to one aspect, a method comprising using at least one hardware processor to: receive a request to generate a first code to be associated with a cannabis producer; receive licensing information for the cannabis producer; verity the licensing information; receive product information related to the cannabis product; receive a list of approved vendors and their locations who can sell the cannabis product; generate the first code; update a master database with the first code, licensing information, product information, and list of approved vendors and locations; receive a scan of a second code associated with a cannabis product; and verify the legitimacy of the second code using the master database.

The method may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a product authentication and verification system, according to an embodiment; and

FIG. 4 illustrates a process for authenticating and verifying a product, according to an embodiment.

### DETAILED DESCRIPTION

After reading this description, it will become apparent to one skilled in the art how to implement various alternative embodiments of the systems and methods described and how to implement the systems and methods in alternative applications. Although various embodiments are described herein, it is understood that these embodiments are presented by way of example and illustration only, and not limitation. As such, this detailed description of various embodiments should not be construed to limit the scope or breadth of the present invention as set forth in the appended claims.

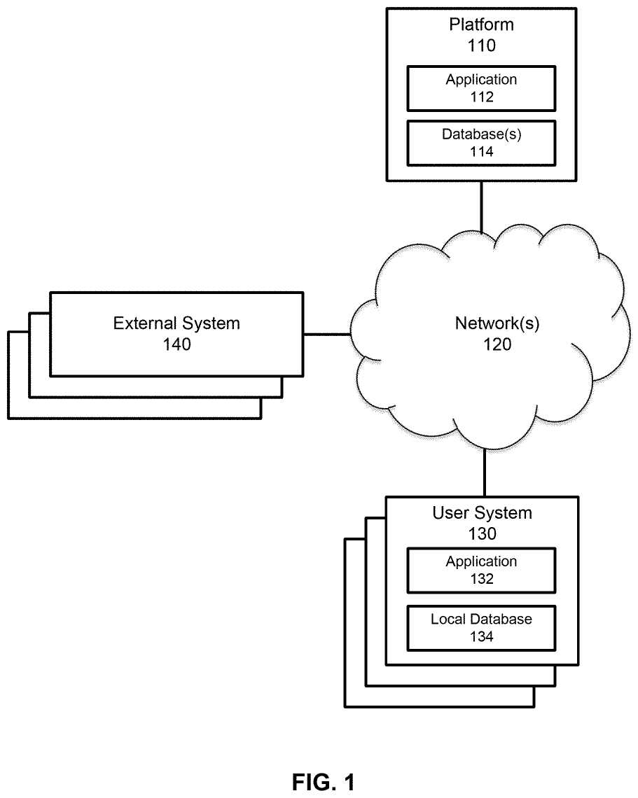

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

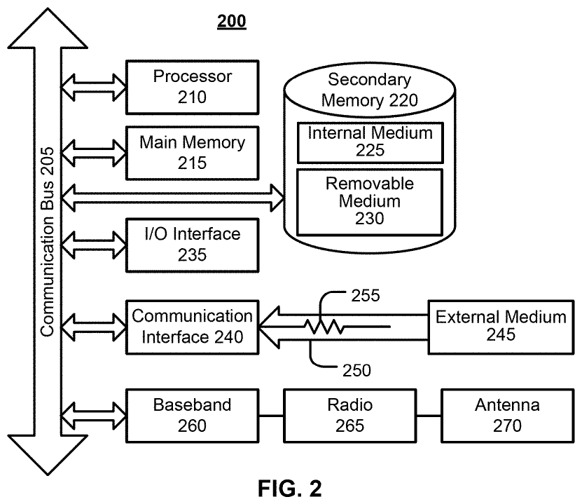

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

Embodiments of processes for product authentication and verification will now be described in detail. It should be understood that the described processes may be embodied in one or more software modules that are executed by one or more hardware processors (e.g., processor 210), for example, as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Certain embodiments described herein make use of barcodes. Universal product codes (UPC), also known as “barcodes” are provided on packaging for goods, or on the goods themselves. Typically, each different item has a different barcode, and identical items have the same barcode. The barcode is typically a twelve digit number and also a corresponding pattern of thinner and thicker “bars” which are elongate in form extending vertically and spaced from each other horizontally, and often with an associated number also presented adjacent thereto. A scanning tool can easily recognize this pattern and identify the associated number by correlating the pattern of lines to the barcode number using a widely known algorithm. If the scanner is coupled to a database, this number can link to information within that database.

A conventional use for barcodes when placed upon items for sale, is to speed up the process of check out at the end of a shopping session. Rather than a clerk having to enter items purchased and price amounts associated with each item, the database automatically populates the receipt as purchased items are scanned, by having the scanner review the barcode and access the retailer's database. This database of information can be created by the store; however, the provider of the item often provides at least some information, so that constructing and/or updating/optimizing the database is not a burden placed upon the store. This product/item information can include a short title of the item, and various other details about the product/item associated by the vendor with the product/item and with the barcode. Price information, such as a suggested retail price, can be initially provided by the vendor of the item, but the store can typically change this price information if desired.

Barcodes originate with the GS1 Global Standards Organization located in Belgium, and with a U.S. affiliate, GS1 US, Inc. of Lawrenceville, N.J. GS1 sells or otherwise provides individual barcode numbers or blocks of barcode numbers to purchasers. Those purchasers might be providers of items for sale, or might be intermediary parties, many of which act as registrars to provide the barcodes they obtain from GS1 to vendors, typically along with other beneficial services, such as automatic creation of product/item pages of information for placement within databases, such as retailer databases, to simplify the process of including the provider's items in various retailer' database systems, and facilitate inclusion of the provider's items in the offerings of the various retailers.

In many instances it is desirable to know who owns a particular barcode, and to access product information about the item/product associated with each barcode. GS1 does not typically or easily provide such information, making it difficult to reliably obtain the name of the barcode owner. Some intermediary companies do provide some such information, in a more easily searchable database, but this information tends to be limited. One example of such a company is found on the Internet at www.upcitemdb.com. Such intermediary company information tends to focus on who obtained the barcode from GS1; however, because barcodes can be transferred, and are often first purchased from GS1 by an intermediary/registrar, and then later provided to a separate vendor, existing databases do not provide the desirable link between the barcode number and the final product and/or vendor of the product associated with that barcode. Thus, the benefit of conventional barcode searching tools and systems is limited.

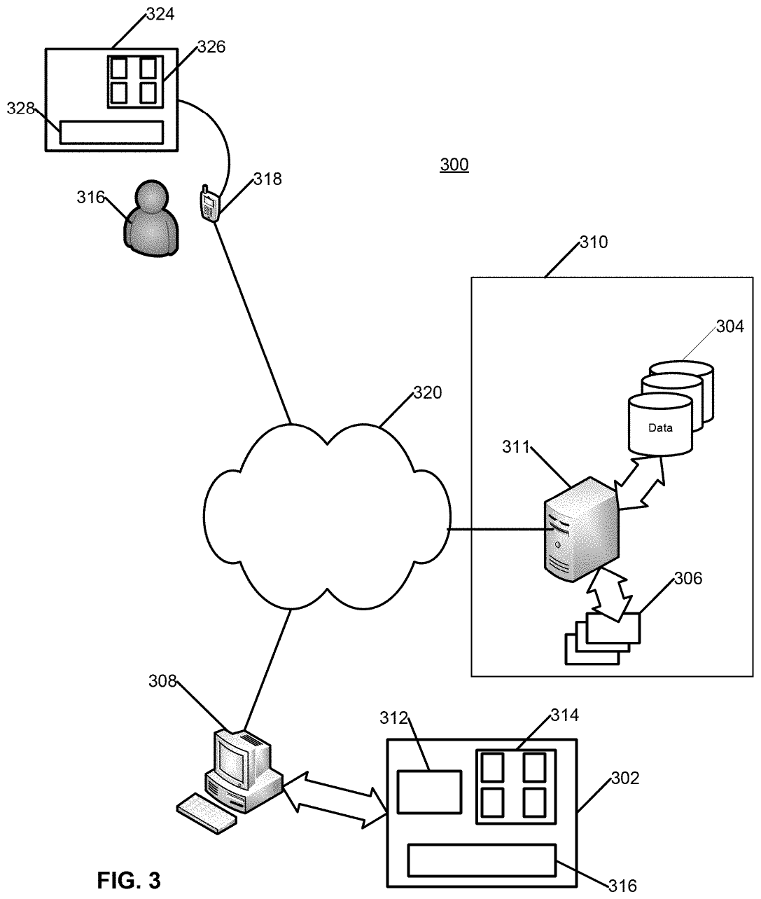

Accordingly, in certain embodiments, a barcode registration and verification system 300, as illustrated in FIG. 3 is provided that provides verification of the owner of a barcode. This owner of the barcode can be a registrar or other intermediary, such as if the barcode is not yet owned by a product/item vendor, or can be a product/item vendor that has acquired the barcode for association with goods provided by the vendor. Furthermore, the barcode registration system can provide information about a particular product if the vendor or other owner of the barcode has associated that barcode with a particular product.

As illustrated in FIG. 3, system 300 can comprise a barcode registry and verification platform 310, which can be an implementation of platform 110, comprising one or more servers 311 interfaced with one or more databases 304 and configured to run one or more programs, processes, algorithms, etc., 306. A barcode owner can then register their barcodes with platform 310. In the example of FIG. 3, the barcode owner can associate a barcode 316 with a product and then register the barcode 316 with platform 310 via a computer, tablet, etc., 308. Because the barcode 316 is associated with the product, the barcode owner can then provide product information 312 and/or images 314 of the product. This information can then be stored in the one or more databases 304.

Computer 308 and platform 311 can communicate via a network 320.

In certain embodiments, the vendor can access platform 311 to create a product page with product information, including images as described below. Platform 311 can be configured to automatically create a barcode for the product and assign that barcode to the vendor for use on the product.

Platform 310 allows for quick and simple verification of who owns a barcode. If a product has been associated with the barcode, such a platform 310 can also provide quick and easy access to information about the product. For instance, sometimes products undergo recalls. If a vendor of items for sale needs to recall a product, this information could be simply added by such a vendor within such a database(s) 304. Others could then simply do a barcode search of the system and see if any recall has been issued for the item of goods, and what the details are of such a recall. p Information 312 can include shipping weight, shipping size, other shipping details, nutritional information, perishability data, and an endless variety of other information, preferably structured within a database for further and more complex searching of the database(s) 304.

In certain embodiments, platform 310 can preferably aggregate data from one or more (typically three) different sources, such as including the GS1 database of barcodes, basic intermediary barcode ownership data based largely on GS1 initial transfer data, such as that provided on the internet at www.upcitemdb.com, and a database(s) 304. An application program interface (API), which can be part of the programs 306, can query these other databases or sources and then create a “master” database. In one embodiment, at least two steps of database population are included, including a first step of querying other database(s), and receiving the vendor information 302. The master database can then be created by populating the master database with information from the other database and the vendor information 302, and if vendor information 302 differs from the queried information, having the vendor information control.

As such, not only is access to useful information about the owner of the barcode facilitated by this master database (and potential product information associated with the barcode), but also a form of verification of the barcode can be provided. This is important because, some systems for vending of items to others require barcode verification, such as to avoid improper assignment of the wrong barcodes to various goods provided on some platforms. As one example, the product vending system accessible on the internet at www.amazon.com, provided by Amazon, requires barcode verification before utilization of barcodes within their product vending system. Conventional systems/databases can only verify who acquired a barcode directly from GS1, and does not accurately verify barcodes that have been transferred between parties, or obtained from registrars or other intermediaries.

The master database described above can be used, however, by such vending systems or ecosystems to verify the correct owner of a barcode, regardless of whether the owner directly obtained the barcode from GS1. Further authentication can also be provided, in certain embodiments, such as providing vendors with authentication and verification credentials, such as usernames, passwords, and other credential regimes, so that, for instance, if a vendor needs to change product information associated with a barcode, such changes can only be performed by the vendor and other authorized parties. If the vendor wishes to transfer barcodes to another individual, so that barcode ownership information changes, such credentials could similarly be used to verify such transactions.

Vendors who choose to fully utilize the benefits of this master database can populate product information associated with each barcode, as noted above. This information can then be changed by the vendor if product information changes, or to add additional information to the database. The master database is structured in such a way that it can readily be linked to various different vending systems, and particularly online vending systems. As an example, the product database populated by the vendors for their products, which are associated with particular barcodes, can be provided in a form which allows for automatic generation of a submission in proper format for sending to Google product feeds, provided by Google, Inc. and that allow for items of goods to be distributed to multiple product vending platforms.

As an example, should a product vendor desire to make an item of goods associated with a barcode widely available on many different vending platforms, the vendor provides product information in the master database associated with the barcode. These pages of information about the products and associated with each barcode can be automatically adjusted to match the Google product feeds, and then the system further links the product to these Google product feeds so that the product of the vendor appears on these different retail platforms as an item available for sale. A vendor thus has the benefit of merely filling out one page of information about the product, and this product then appears on numerous different retail platforms as a product available for sale.

Information 302 in this database that is supplied by the product vendor can include images of the item, pricing information, shipping information, weight information, and other relevant information which can be provided in such Google product feeds, or other related product feed services.

Platform 310 can also be used by consumers to authenticate products and the verify that the vendor is an authorized vendor of the product. As illustrated in FIG. 3, a consumer 316 can download an application to their mobile device 318. When the consumer 316 goes to a store 322 to purchase a product, the user can obtain information 324 related to the product and a scan of the barcode and provide them to platform 310 via their device 318 and platform 310 can verify the barcode 328 on the product. The application can also gather location information, e.g., via GPS or some other method, and can provide the scanned barcode and location information to platform 310. Platform can then verify, based on the barcode and location information whether the vendor associated with store 322 is authorized to sell the product.

In certain embodiments, the consumer 316 can also upload images 326 to platform 310. Platform 310 can then compare images 326, e.g., against images 314 to authenticate that the product is not a counterfeit. In certain embodiments, computer vision algorithms can be used to compare the two sets of images. These algorithms can be part of algorithms 306, or can be part of a remote service such as Amazon Rekognition platform. In such embodiments, a model can be built for the product, based on the initial images 314. This model can then be used to authenticate the images 326. Images 326 can then be used to update the model.

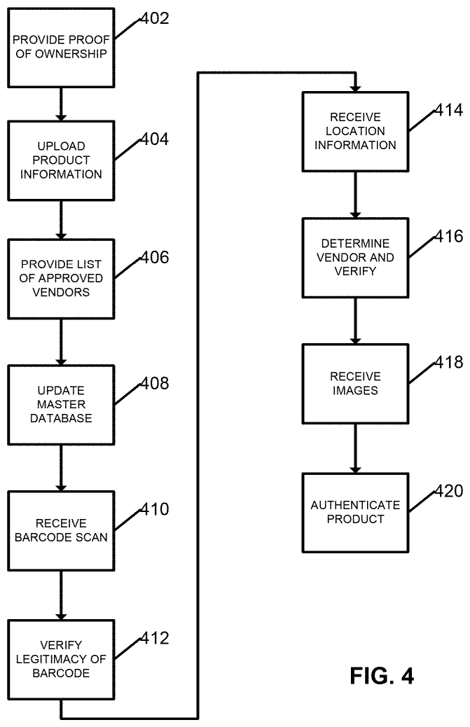

FIG. 4 is a flow chart illustrating a method for verifying a vendor and authenticating a product in accordance with one embodiment. First, in step 402, the product vendor and barcode owner can provide the barcode and proof of ownership. Then in step 404 the vendor can provide product information and, in step 406, a list of approved vendors who can sell the product. In step 408, the master database can be updated with the information.

When a scan of the barcode is then received in step 410, the master database can be used to verify the legitimacy of the barcode. Location information can then be received in step 414, which can be used, in step 416 to determine the vendor and verify whether the vendor is authorized to sell the associated product. As noted above, in certain embodiments, images of the product can also be received, in step 418 and used to authenticate the product in step 420.

Of course, if the vendor is not verified in step 416 and/or the product is not authenticated in step 420, then both the consumer 416 and the barcode owner can be notified. Allowing the vendor to more easily identify fraudulent sales and/or counterfeiting and the consumer piece of mind that they are buying authentic products.

In one particular implementation, the system 300 of FIG. 3 can be used for a cannabis registry. In such an implementation, a bar code, or in certain embodiments a CR code, can be placed on the package. In, e.g., California a cannabis producer must be licensed. But a large portion of the cannabis sold is either counterfeit or not produced by a licensed producer. Thus, system 300 can be used to verify codes that can be placed on the packaging and to store images of the packaging that can be verified at purchase.

The producer can therefore upload images of their packaging, list of authorized vendors, their licensing information, product information, etc. A code, e.g., CR code on the packaging can then be scanned by a consumer, which can launch a website that will pull up the information and confirm that the packaging is not counterfeit, the location is an authorized location, confirm that the producer is licensed, etc. The GPS coordinates of the consumers device can be used to confirm the location is an authorized seller of the product.

Similarly, the delivery drivers and the stores can generate codes as they need to be licensed as well. Thus, the store can confirm the delivery person is licensed, and the consumer can confirm the store is licensed using the application and scanning the code.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive a request to generate a first code to be associated with a cannabis producer;
receive licensing information for the cannabis producer;
verity the licensing information;
receive product information related to the cannabis product;
receive a list of approved vendors and their locations who can sell the cannabis product;
generate the first code;
update a master database with the first code, licensing information, product information, and list of approved vendors and locations;
receive a scan of a second code associated with a cannabis product; and
verify the legitimacy of the second code using the master database.

2. The method of claim 1, further using the at least one hardware processor to:
receive location information;
determine a vendor associated with the location information; and
verify whether the vendor is authorized to sell the cannabis product based on the location information and using the master database.

3. The method of claim 1, further using the at least one hardware processor to:
receive a first set of images of packaging associated with the cannabis product;
update the master database with the first set of images;
receive a second set of images of the cannabis product; and
authenticate the cannabis product based on the first and second set of images.

4. The method of claim 3, further using the at least one hardware processor to: authenticate the cannabis product using computer vision algorithms and a model of the cannabis product built using the first set of images.

5. The method of claim 1, further using the at least one hardware processor to send a notification to a consumer when the second code is verified or not.

6. The method of claim 1, further using the at least one hardware processor to send a notification to the vendor when the second code is verified or not.

7. The method of claim 1, further using the at least one hardware processor to send a notification to a consumer when the vendor is verified or not.

8. The method of claim 1, further using the at least one hardware processor to send a notification to the vendor when the vendor is verified or not.

9. The method of claim 1, further using the at least one hardware processor to send a notification to a consumer when the cannabis product is authenticated or not.

10. The method of claim 1, further using the at least one hardware processor to send a notification to the vendor when the cannabis product is authenticated or not.
